(19) United States
(12) Patent Application Publication
(10) Pub. No.: US 2017/0024805 A1
(43) Pub. Date: Jan. 26, 2017

(54) SYSTEMS AND METHODS FOR FACILITATING CUSTOMER INTERACTION DURING PICK-UP OF RETAIL ORDERS

(71) Applicant: HEB Grocery Company, LP, San Antonio, TX (US)

(72) Inventors: Paul Steven Tepfenhart, JR., San Antonio, TX (US); Kedar Dilip Patel, San Antonio, TX (US); Gabe William Roach, San Antonio, TX (US); John Matthew Steele, San Antonio, TX (US); Christopher Alan Bigley, San Antonio, TX (US)

(21) Appl. No.: 14/807,639

(22) Filed: Jul. 23, 2015

(51) Int. Cl. G06Q 30/06; G06Q 10/08

(52) U.S. Cl. CPC G06Q 30/0635; G06Q 10/0836

(57) ABSTRACT

Systems, methods, and computer programs for facilitating customer interaction and fulfillment relating to orders for items and/or services sold by retailers and provided to customers for pick-up are provided. In certain embodiments, the methods comprise: receiving a customer arrival notification for a customer to pick up at a pick-up facility one or more items purchased from a retailer in an order previously placed by the customer; determining an estimated order pick-up time for the order; and providing an electronic pick-up notification to the customer that includes the estimated order pick-up time.

### BACKGROUND

The present disclosure generally relates to systems, computer programs, and methods for facilitating customer interaction and fulfillment relating to orders for items and/or services sold by retailers and provided to customers for pick-up.

In many situations, retailers of goods and services both own and/or operate one or more “brick-and-mortar” retail stores and/or physical facilities where customers may browse, purchase, and/or pick up items at the site, and also provide an online website or other service for receiving orders from customers remotely. In the methods and systems of the present disclosure, such retailers may allow customers to place orders for goods or services via a website or other service for receiving orders, but rather than shipping or delivering the purchased items to the customer's home (or other location designated by the customer), the retailer may fulfill those orders to the customer by making the set of items purchased by the customer available at a pick-up facility (e.g., a retail store or other “brick-and-mortar” facility) that may be operated or used by the retailer.

Today's consumers demand convenience, speed, selection, and high quality from their retailers regardless of whether such consumers are shopping online or are shopping in a brick-and-mortar establishment. Thus, in order to maximize customer satisfaction, a retailer must meet a consumer's expectations on these attributes when fulfilling items to a customer via customer pick-up. Delayed or unreliable provision of items for customer pick-up at brick-and-mortar facilities or a failure to provide customers with sufficient information to efficiently take advantage of customer pick-up at those facilities may cause customers to be dissatisfied with those systems or the retailer more generally, which ultimately may result in the loss of sales by that retailer.

### SUMMARY

The present disclosure generally relates to systems and methods for facilitating customer interaction and fulfillment relating to orders for items and/or services sold by retailers and provided to customers for pick-up.

In one embodiment, the present disclosure provides a method comprising: receiving a customer arrival notification for a customer to pick up at a pick-up facility one or more items purchased from a retailer in an order previously placed by the customer; determining an estimated order pick-up time for the order; and providing an electronic pick-up notification to the customer that includes the estimated order pick-up time.

In another embodiment, the present disclosure provides a computer program stored in a tangible medium for processing information relating to the pick-up of online retail orders, the program comprising a plurality of instructions that when executed cause at least one processor to: receive a customer arrival notification for a customer to pick up at a pick-up facility one or more items purchased from a retailer in an order previously placed by the customer; determine an estimated order pick-up time for the order; and provide an electronic pick-up notification to the customer that includes the estimated order pick-up time.

In another embodiment, the present disclosure provides a system for managing pick-up of online retail orders comprising: a data server that comprises at least one processor, a communications interface configured to receive data from and send data to one or more client systems, and a memory comprising executable instructions that, when executed, cause the at least one processor to: receive a customer arrival notification for a customer to pick up at a pick-up facility one or more items purchased from a retailer in an order previously placed by the customer; determine an estimated order pick-up time for the order; and provide an electronic pick-up notification to the customer that includes the estimated order pick-up time.

The features and advantages of the present disclosure will be apparent to those skilled in the art. While numerous changes may be made by those skilled in the art, such changes are within the spirit of the invention and disclosure.

### BRIEF DESCRIPTION OF THE FIGURES

Some specific example embodiments of the disclosure may be understood by referring, in part, to the following description and the accompanying figures.

FIG. 1 is a flowchart depicting a process for preparing a customer's order for pick-up by the customer according to certain embodiments of the present disclosure.

FIG. 2 is a flowchart depicting a process for determining an estimated order pick-up time according to certain embodiments of the present disclosure.

FIG. 3 is a diagram depicting a portion of an order fulfillment system for pick-up of items according to certain embodiments of the present disclosure.

While the present disclosure is susceptible to various modifications and alternative forms, specific example embodiments have been shown in the figures and are herein described in more detail. It should be understood, however, that the description of specific example embodiments is not intended to limit the invention to the particular forms disclosed, but on the contrary, this disclosure is to cover all modifications and equivalents as illustrated, in part, by the appended claims.

### DESCRIPTION OF EMBODIMENTS

The present disclosure generally relates to systems, computer programs, and methods for facilitating customer interaction and fulfillment relating to orders for items and/or services sold by retailers and provided to customers for pick-up.

More particularly, the present disclosure provides systems, computer programs, and methods for providing certain notifications to a customer who has provided a notification of their arrival or anticipated/imminent arrival at a pick-up facility such as a retail store location or other “brick-and-mortar” facility to pick up a previously-placed order (e.g., an order placed through an online system) for goods or services provided by a retailer. In response to the customer's arrival notification to the retailer (e.g., via text message, e-mail, or other communication from a customer's portable electronic device, by checking in at a kiosk provided at the pick-up facility, and/or by checking in with personnel at the pick-up facility), the methods and systems of the present disclosure performs two operations: (1) determine “an estimated order pick-up time” at which the items in the customer's order will be collected, packaged, or otherwise prepared and ready for the customer to pick up, and (2) provide an electronic notification to the customer that includes the estimated order pick-up time. The estimated order pick-up time is calculated when the customer provides an arrival notification to the retailer, and may be determined based on one or more of the following factors: (1) the number of runner personnel on duty at the pick-up facility at the customer's arrival time, (2) the number of runner personnel available (i.e., not assigned to a different task) at the pick-up facility at the customer's arrival time, (3) the number of pick-up orders in a queue awaiting preparation for pick-up at the pick-up facility, (4) the number of items in the customer's order, and (5) the number of different areas of the pick-up facility from which the items in the customer's order must be retrieved (also referred to as “putaway locations”). The present disclosure also provides computer programs stored in a tangible medium comprising a plurality of instructions that when executed cause at least one processor to perform some or all of the methods described herein. The present disclosure also provides systems that are configured to calculate an estimated order pick-up time and provide electronic notifications to a customer (e.g., in a substantially automated fashion) according to the methods described herein.

Among the many potential advantages to the methods and compositions of the present disclosure, only some of which are alluded to herein, the methods and systems of the present disclosure may provide a more efficient, convenient, and/or flexible means of managing pick-up of customer orders, among other ways, by providing more accurate estimates of order pick-up times. In some embodiments, more accurate estimates of order pick-up times may provide customers greater convenience, reliability, and/or predictability in picking up orders at a pick-up facility, any or all of which may increase customer satisfaction. In some embodiments, more accurate estimates of order pick-up times may allow retailers and users to provide orders for pick-up more efficiently, for example, by decreasing the formation of a back-up of customers waiting in a particular area of a store or other location for their order. In certain embodiments, providing an accurate estimated pick-up time may encourage customers to shop for additional items at a retail store while they wait, which may increase the retailer's overall sales. In still other embodiments, the methods and systems of the present disclosure may enable a retailer to pick, collect, or prepare items for a customer's order closer to the time at which they are actually picked up, and thus provide certain types of items to the customer in a more “fresh” state as compared to if the items were picked, collected, or prepared prior to the customer's arrival at the pick-up facility.

The retailers who may operate or use the methods and systems of the present disclosure may include any entity who sells and/or provides goods or services to customers, including but not limited to grocery retailers. The goods or items provided using the methods and systems of the present disclosure may include any suitable goods. In certain embodiments, the goods or items may comprise food or grocery items, including but not limited to pre-packaged food items, perishable food items (e.g., meat, produce, delicatessen items, bakery items, etc.), refrigerated or frozen food items, and the like. These goods or items may be purchased by the retailer from another source, or may be created, packaged, or prepared (in whole or in part) by the retailer. In some embodiments, the goods or items may be “made to order” and/or customized per the customer's request and/or specifications. In certain embodiments, the goods or items may be stored and/or provided as a part of the inventory of a retail store location, either in a stockroom or in the retail space accessible to customers at the store.

In the methods and systems of the present disclosure, it is also understood that the descriptions of activities of or involving a customer (e.g., pick-up of items, arrival at a pick-up facility, triggering/sending/receiving notifications) may include those activities that may involve or be performed by a customer's agent or designee that has been tasked with picking up previously ordered items from a pick-up facility. In certain embodiments, such an agent or designee may be a representative or employee of a third-party courier, delivery, or shopping company authorized by the customer and/or retailer to pick up items ordered by the customer (either separately or through the third-party company) at the pick-up facility.

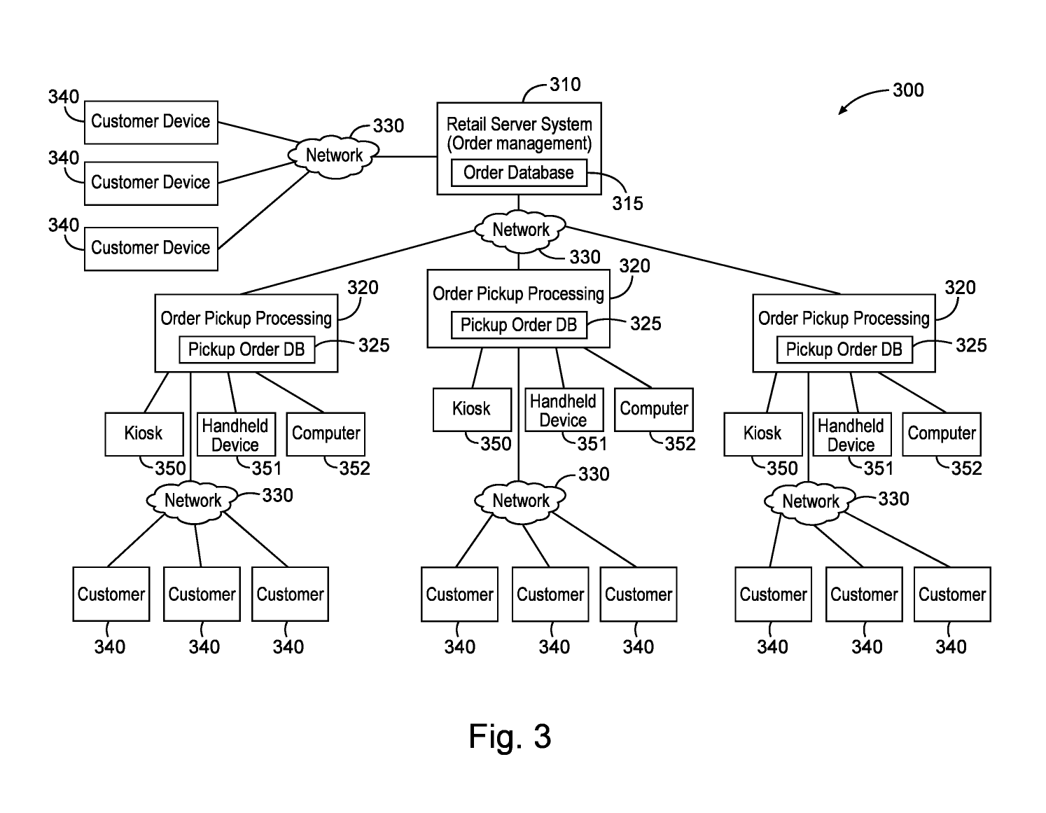

FIG. 3 illustrates an example system 300 for implementing an order pick-up processing system according to certain embodiments of the present disclosure. This system involves a system configured for client-server interaction and communication, which refers to a distributed system in which a program at one site sends a request to a program at another site and waits for a response. The requesting program is called the “client,” and the program which responds to the request is called the “server.” Client-server systems may exist in the Internet (which refers to a collection of interconnected (public and/or private) networks that are linked together by a set of standard protocols (such as TCP/IP and HTTP) to form a global, distributed network), the World Wide Web, or other networks either public or private in nature. While this term may refer to what is now commonly known as the Internet, it is also intended to encompass variations which may be made in the future, including changes and additions to existing standard protocols. In the context of the Internet or the World Wide Web, the client is a “Web browser” (or simply “browser”) which runs on a computer of a user; the program which responds to browser requests by serving Web pages is commonly referred to as a “Web server.” A website or retailer server system of the present disclosure serves informational content over a network, typically using the standard protocols of the World Wide Web.

System 300 includes a retail server system 310 operated by a retailer that is connected to (e.g., through a direct communication link or a communication network) a plurality of order pick-up processing servers 320, each of which may be located at or designated for a particular pick-up facility. In certain embodiments, one or more of order pick-up processing servers 320 may comprise virtual servers that are physically located on a single piece or group of hardware components at a single physical location (e.g., a retail store or other facility). In the embodiment shown, the retail server system 310 and each of the plurality of order pick-up processing servers 320 may be connected to and/or communicate with one or more customer devices 340 used by customers through one or more networks 330. Although FIG. 3 illustrates a particular arrangement of customer devices 340, retailer server system 310, order pick-up processing servers 320, and networks 330, this disclosure contemplates any suitable arrangement of those devices, servers, and networks. Although FIG. 3 illustrates a particular number of customer devices 340, retailer server systems 310, order pick-up processing servers 320, and networks 330, this disclosure contemplates any suitable number (e.g., one or more) of those components. As an example and not by way of limitation, system 300 instead may comprise multiple retailer server systems 310 (e.g., servers of multiple different retailers connected to common order pick-up processing servers 320 operated by a third party), or a single centralized order pick-up processing server that may process information for a plurality of different pick-up facilities. As another example and not by way of limitation, one or more retailer server systems 310 and one or more order pick-up processing servers 320 may be physically or logically co-located with each other in whole or in part. System 300 also may comprise any number of intermediate servers and/or networks between one or more of customer devices 340, retailer server systems 310, order pick-up processing servers 320, and networks 330. For example, the data provided to customer devices 340 for display to a customer and/or data provided to order pick-up processing servers 320 may be processed or passed through one or more additional servers or computer systems hosted by a third party network or server provider. Such intermediate servers and/or networks may run additional software or further process data received from customer devices 340 and/or order pick-up processing servers 320 before transmission of that data elsewhere in the system.

Server systems used in the methods and systems of the present disclosure such as retailer server system 310 and/or order pick-up processing servers 320 generally comprise at least one processor, memory (e.g., random access memory (RAM) or read-only memory (ROM)) that may comprise executable instructions for the processor, and a communications interface configured to transmit data (e.g., pick-up time notifications and/or data relating thereto) to and receive data (e.g., customer arrival notifications and/or data relating thereto) from other computer systems or devices. The processor may comprise any microprocessor, central processing unit (“CPU”), or other computer processors known in the art, and the communications interface may comprise any type of computer interface device known or used in the art with electronics and computer systems, including but not limited to modems, Ethernet/Wi-Fi/LAN/cellular adapters, serial connections, data bus connections, and other similar types of devices. The processor may include an internal memory device and/or be configured to access a separate memory device or drive comprising executable instructions. Data servers suitable for use in the retailer server systems in the present disclosure include those commercially available from Dell, IBM, and Apple. The retailer server system also may include multiple redundant servers that operate as mirrors of each other, which may, among other purposes, increase speed of the system and/or help compensate for failures or other problems in the servers. In particular embodiments, retailer server system 310 and/or order pick-up processing servers 320 may be network-addressable computing systems that can host one or more retailer's server systems. In particular embodiments, retailer server system 310 and/or order pick-up processing servers 320 may be capable of receiving and/or generating communications in the form of email messages, text messages (e.g., SMS, MMS, or any other known format), push notifications, instant messages, voicemails, audio recordings, video recordings, or any other suitable form of electronic messages.

A retailer server system 310 may generate, store, receive, and transmit various types of data relating to online orders, including but not limited to item-related data (e.g., images, pricing, inventory availability, perishability, customization options, size/weight data, promotional information, and/or other attributes), customer-related data (e.g., names, addresses, phone numbers, e-mail addresses, communication preferences, purchase histories, payment information, etc.), store-related data (e.g., addresses, store departments, inventory, etc.) and the like. For example, as shown in FIG. 3, retailer server system 310 may include an order database 315 that stores data records for orders for items placed by a customer, for example, via an online ordering system. A retailer server system 310 may be accessed by and/or communicate with the other components of system 300, either directly or via a network or a third-party system.

The order pick-up processing servers 320 may generate, store, receive, and transmit various types of data relating to online orders (or items in such orders) to be fulfilled to the customer via a particular pick-up facility. That data may include but is not limited to item-related data (e.g., item inventory availability, perishability, customization options, size/weight data, putaway locations, and/or other attributes), customer-related data (e.g., names, addresses, phone numbers, e-mail addresses, communication preferences, purchase histories, payment information, etc.), store-related data (e.g., addresses, store departments, inventory, runner personnel information, etc.) and the like. For example, as shown in FIG. 3, order pick-up processing servers 320 may include pick-up order databases 325 that store data records for orders for items to be picked up at a particular pick-up location. In certain embodiments, the pick-up order databases 325 may be populated by a certain number of order records sent by retail server system 310 or accessed from order database 315. In particular embodiments, one or more customers may use one or more customer devices 340 to access, send data to, and receive data from order pick-up processing servers 320. In certain embodiments, one or more computing devices such as kiosks 350, handheld devices 351, and computer terminals 352 provided at the pick-up facility and/or operated by personnel at the pick-up facility may be connected to the order pick-up processing servers 320 to access, send data to, and receive data from order pick-up processing servers 320. A customer device 340, kiosk 350, handheld device 351, or computer terminal 352 may access or communicate with an order pick-up processing server 320 directly, via a network (e.g., similar to network 330), or via a third-party system.

A customer device 340, kiosk 350, handheld device 351, and/or computer terminal 352 may include any suitable computing device, such as, for example, a laptop computer, a cellular phone, a smartphone, a personal digital assistant, an ultra-mobile PC, a computing tablet, a portable media player, a pocket computer, or the like. In many embodiments, the customer device 340 is a portable device such as a smart phone or tablet that a customer can easily carry when they enter the pick-up facility. In particular embodiments, the customer device 340 includes a processor, a memory (e.g., RAM or ROM) that comprises executable instructions for the processor, and a communication interface. Kiosks 350 and/or computer terminals 352 also may comprise other forms of computing devices, including desktop computers, thin client terminals, and the like. In certain embodiments, suitable customer devices 340, kiosks 350, handheld devices 351, and/or computer terminals 352 may comprise storage, an input/output (I/O) interface, communication buses, and other components. This disclosure contemplates any suitable device having any suitable number of any suitable components in any suitable arrangement. The customer device, kiosk, handheld device, and/or computer terminal may include, incorporate, or interface with various types of input and output devices. Suitable output devices may include, but are not limited to, display monitors, audio speakers, printers, or the like. Suitable input devices may include, but are not limited to, touch screens, mouses, keyboards, microphones, motion detection systems/sensors, near-field communication devices, scanners (e.g., barcode scanners), cameras, or the like.

Networks 330 may be any suitable communications networks. As an example and not by way of limitation, one or more portions of networks 300 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 330 may include one or more networks 330.

Various types of connections may connect customer devices 340, retailer server systems 310, order pick-up processing servers 320, networks 330, kiosks 350, handheld devices 351, and/or computer terminals 352 and/or third party carrier servers to each other. This disclosure contemplates any suitable connections. In particular embodiments, one or more connections include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)) or optical (such as for example Synchronous Optical Network (SONET) or Synchronous Digital Hierarchy (SDH)) connections. In particular embodiments, one or more connections 301 each include an ad hoc network, an intranet, an extranet, a VPN, a LAN, a WLAN, a WAN, a WWAN, a MAN, a portion of the Internet, a portion of the PSTN, a cellular telephone network, another connection, or a combination of two or more such connections. The connections need not necessarily be the same throughout system 300. One or more first connections may differ in one or more respects from one or more second connections.

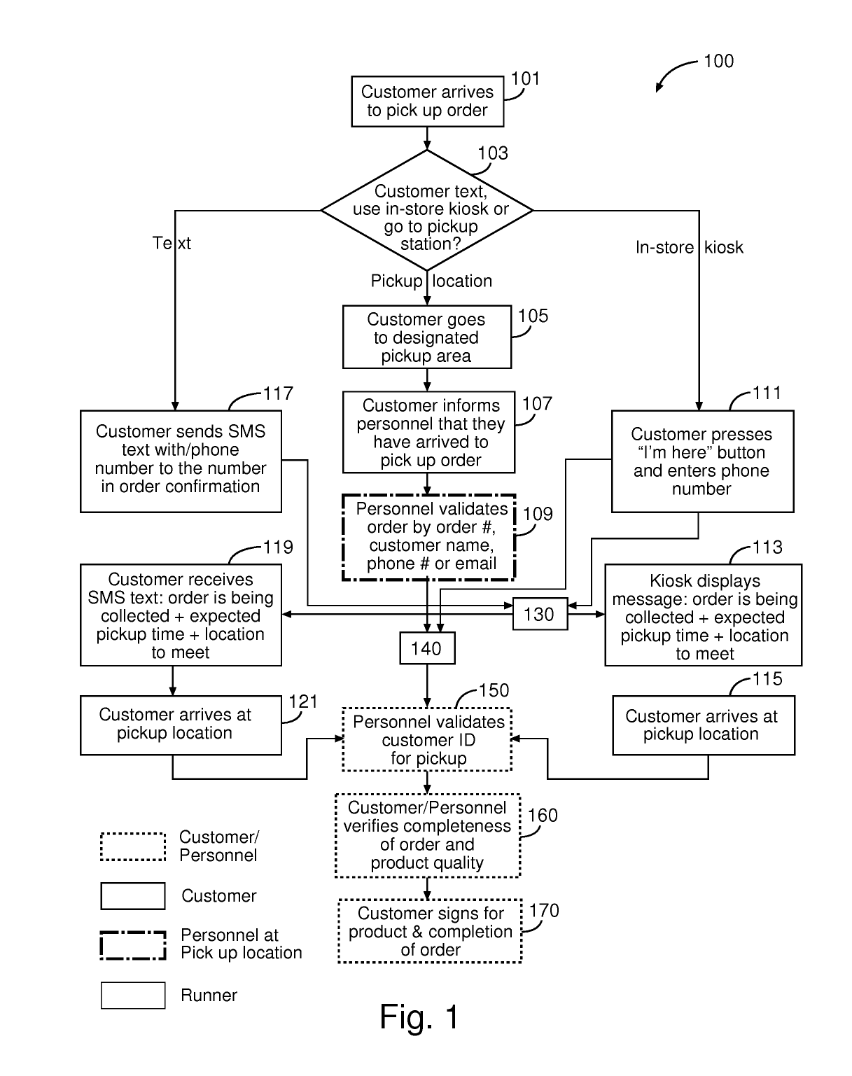

FIG. 1 is a flowchart illustrating a process 100 of the present disclosure that may be used to facilitate the preparation and pick-up of items in a previously-placed order with the retailer. In certain embodiments, the customer may have previously placed their order for items with the retailer through an online ordering system or by phone, or may have been placed by the customer during a prior visit to a retail store or other facility operated by the retailer. In certain embodiments, the particular pick-up facility where the customer will pick up their order and/or a scheduled date/time window when the order can be made available for pick-up (e.g., an earliest date/time when the order will be available) is selected and/or assigned at the time that the order was placed or at any other point in time prior to pick-up. The pick-up facility and/or the scheduled date/time for pick-up may be selected and/or assigned by the customer, the retailer, or a third party involved in the processing of the order.

At block 101, in the embodiment shown, the customer arrives at the pick-up facility to pick up the order. However, it will be understood by a person of ordinary skill in the art that, in certain embodiments of the present disclosure, the customer may provide a customer arrival notification at some point in time prior to their physical arrival at the pick-up facility in anticipation of that arrival. In certain embodiments, the customer may provide an arrival notification from some other location via a remote means of communication (e.g., at block 117, as described below), for example, when they are preparing to travel to the pick-up facility, while in transit to the pick-up facility, and/or from a location just outside the pick-up facility (e.g., a parking lot, drop-off location, etc.).

At block 103, the customer chooses a means of notifying the order pick-up processing server of his arrival at the facility. The embodiments illustrated in FIG. 1 provides for three possible means of providing a customer arrival notification, each of which are described below. In block 117, the customer sends an arrival notification from their personal device (e.g., smartphone) to the order pick-up processing server. This arrival notification may be sent in the form of an email message, a text message (e.g., SMS, MMS, or any other known format), a push notification, an instant message, an audio or video recording, or any other suitable form of electronic message containing the indicated information. In the embodiment shown, the customer sends an SMS text message to a phone number that is monitored by a system capable of sending data from incoming text messages to the order pick-up processing server (which may be provided to the customer in an order confirmation). The text message may include the customer's phone number (i.e., the phone number that the customer provided in placing their order), order number, or other information associated with the customer's order. The customer may enter the digits of their phone number in the SMS text message itself, or the customer's phone number may be communicated to the order pick-up processing server automatically as the number from which the message was sent.

Alternatively, in block 111, the customer goes to a computing device such as a kiosk or networked computer provided at the pick-up facility and provides input indicating their arrival, which may include the customer's phone number, order number, or other information associated with the customer's order. In certain embodiments, the computing device may be provided at a “curbside” location at the pick-up facility where customer vehicles may be parked or located, such that customer may provide their arrival notification from their vehicle and/or await delivery of the items in their order to that curbside location. The computing device sends that information to the order pick-up processing server, either via a common communication network or an electronic message generated by the computing device and sent to the order pick-up processing server as text message, e-mail message, push notification, or other type of electronic communication.

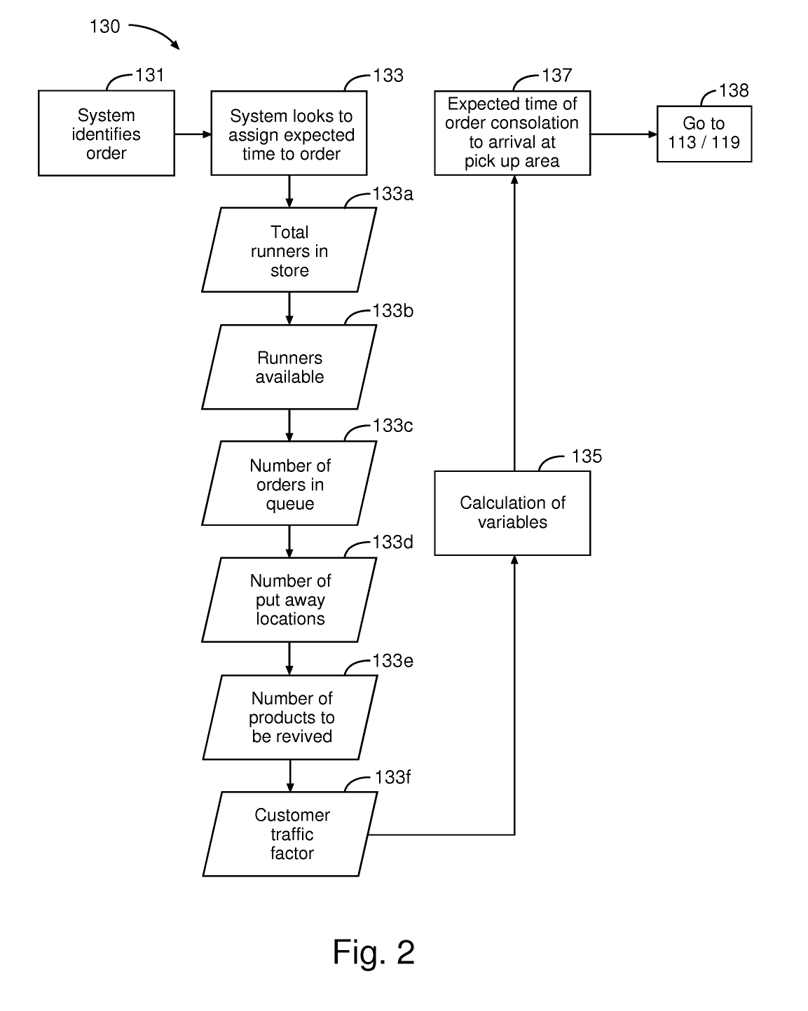

Once the order pick-up processing server receives notice of the customer's arrival via either block 111 or 117, the order pick-up processing server performs sub-process 130 for determining an estimated order pick-up time (e.g., a time at which the order will be ready and/or provided for pick-up by the customer), which is illustrated in the flowchart in FIG. 2. Referring now to FIG. 2, at block 131, the order pick-up processing server uses the customer phone number or other information provided at the computing device or in the text message from the customer's personal device to search for and retrieve an order record in the order pick-up processing server designated for pick-up at that facility. At block 133, the order pick-up processing server retrieves various inputs 133a through 133f relating to the order itself as well as certain variables relating to the pick-up facility. In the embodiment shown these inputs include the number of runner personnel on duty at the pick-up facility at the customer's arrival time, the number of runner personnel available (i.e., not assigned to a different task) at the pick-up facility at the customer's arrival time, the number of pick-up orders in a queue awaiting preparation for pick-up at the pick-up facility, the number of items in the customer's order, the number of putaway locations for the items in the customer's order, and an input factor relating to the amount of customer traffic at the pick-up facility. In certain embodiments, one or more pieces of data relating to inputs 133a through 133f may be stored in the order pick-up processing server. At block 135, the order pick-up processing server uses the inputs 133a through 133f to calculate an expected order pick-up time for the order. In certain embodiments, larger numbers of pick-up orders in the queue, items in the customer's order, and putaway locations, and/or smaller numbers of runner personnel at a pick-up facility may result in longer estimated order pick-up times. In certain embodiments, larger amounts of customer traffic at the pick-up facility (which may be indicated by, for example, particular times of day known to have increased customer traffic, larger numbers of personal electronic devices connected to a wireless network at a pick-up facility, etc.) may increase the amount of time required for runner personnel to collect the items in an order and bring them to a designated pick-up area, which may result in longer estimated order pick-up times. The estimated order pick-up time is generated as an output at block 137, at least initially, as a number of minutes required to pick, collect, or otherwise prepare the order for pick-up. In certain embodiments, this number of minutes may be added to the customer's arrival time as indicated by the time that the customer's arrival notification was sent to or received by the order pick-up processing server, generating an estimated order pick-up time as a particular time of the day at which the order will be ready for pick-up.

Then, at block 138, the estimated order pick-up time (either as a number or range of minutes or a particular time (or time window) of the day) is incorporated into a pick-up time notification provided to the customer on their personal device or the computing device at which they provided their arrival notification, per block 113 or 119 in FIG. 1. The pick-up time notification sent to the customer device at block 119 may be in the form of an email message, a text message (e.g., SMS, MMS, or any other known format), a push notification, an instant message, a voicemail, an audio recording, a video recording, or any other suitable form of electronic message containing the indicated information. In certain embodiments, the estimated order pick-up time and/or pick-up time notification may be sent to a customer device at block 119 for display to the customer within the operation of a software application provided by the retailer that is stored and operated on the customer device. In the instances where the customer arrival notification was provided at a computing device such as a kiosk provided at the pick-up facility, at block 113, a pick-up time notification may be sent to that device for display or other communication (e.g., audio playback, etc.) to the customer. Alternatively, data including the estimated order pick-up time may be sent to the computing device for incorporation into a pick-up time notification generated by the device itself that is displayed or otherwise communicated to the customer. In addition to the estimated order pick-up time, the pick-up time notification may include additional information, including but not limited to a more specific area at the pick-up facility where the items in the order will be made available for pick-up, the name of a runner who will provide the items in the order to the customer, or the like.

In certain embodiments, if the system is unable to identify an order record at block 131 associated with the identifying information provided by the customer that is designated for pick-up at that facility, the order pick-up processing server may generate an alternate notification (not shown) for communication to the customer via their personal device or the computing device at which they provided their arrival notification. This alternate notification may, for example, indicate that no order was identified for the customer and/or instruct the customer to meet an attendant or other personnel at the pick-up facility to further discuss or investigate the status of their order.

Referring to FIG. 1, and specifically to decision block 103 where the customer provides an arrival notification, in blocks 105 and 107, the customer may go to a designated check-in area or place a telephone call to a designated phone number for the pick-up facility and verbally inform an attendant or other personnel that they have arrived to pick-up an order. In certain embodiments, this designated check-in area may include a “curbside” location at the pick-up facility where customer vehicles may be parked or located, such that customer may provide their arrival notification from their vehicle and/or await delivery of the items in their order to that curbside location. In these embodiments, the customer may provide an order number, a customer name, a phone number, an email address, or other information that the attendant or other personnel may use to retrieve an order record in the order pick-up processing server at block 109. In the embodiment shown in FIG. 1, the system does not determine the estimated order pick-up time or provide any notification of that information to a customer notifying the order pick-up processing server of his arrival via the means of blocks 105, 107, and 109. However, in other embodiments, the order pick-up processing server may also determine the estimated order pick-up time, for example, using portions of sub-process 130 as described above. When the estimated order pick-up time is determined, that information may be provided to an attendant or other personnel in the pick-up area in an electronic message or display, who may convey that information to the customer.

Referring to FIG. 1, a person of skill in the art with the benefit of this disclosure will recognize that, in some embodiments, process 100 may allow for additional alternative means of providing notice or a notification of a customer's arrival at the pick-up location to the order pick-up processing server at block 103. For example, in a fourth alternative (not shown), a customer's device automatically sends an arrival notification (e.g., in the form of an email, a text message, a push notification, or other form of electronic communication) to the order pick-up processing server, for example, when the device detects that it is located in or with a certain proximity of the pick-up facility using GPS signals or other location-based technologies used by the device. In a fifth alternative (not shown), an input component in communication with the order pick-up processing server detects when a particular customer device (which has been authorized to be detected in such a manner) is located in or within a certain proximity of the pick-up facility, for example, using various geo-fencing, near-field communication (NFC), and/or biometric technologies known in the art. In a sixth alternative (not shown), when a particular customer device connects to a local network (e.g., an Ethernet or wi-fi communication network) at a pick-up facility, a unique Internet protocol (IP) address or media access control (MAC) address assigned to that device on the network may be used to identify the customer associated with that device to the order pick-up processing system as having arrived at the pick-up facility. In a seventh alternative (not shown), an input component in communication with the order pick-up processing server (or another computing device connected thereto) at the pick-up facility scans a machine-readable code such as a bar code or a QR code displayed by a customer device that is associated with the customer's device, phone number, or other personal information that may be used to retrieve an associated order record in the order pick-up processing server. In these fifth, sixth, and seventh alternative embodiments, the customer device may not send any arrival notification message or data to the order pick-up processing server. However, the present disclosure contemplates all of the alternative embodiments described above as additional means by which the order pick-up processing server may receive a customer arrival notification in accordance with the present disclosure and claims. Following notice of a customer's arrival via any of these alternative means mentioned above, the order pick-up processing server may determine an estimated order pick-up time according to sub-process 130 (or a portion thereof), send or provide a pick-up time notification including the estimated order pick-up time to the customer, and/or assign or instruct runner personnel to collect or prepare the items in the customer's order, for example, according to sub-process 140 as described below.

Once the order pick-up processing server receives notice of the customer's arrival via either block 109, 111, or 117 (or one of the alternative means for providing notice of the customer's arrival discussed above), the order pick-up processing server places the customer's order in a queue (which may be stored on that server) for orders awaiting collection or preparation for pick-up and initiates a sub-process 140 for assigning or instructing one or more runner personnel to collect or prepare the items in the customer's order. In this sub-process, the order pick-up processing server may identify runner personnel that is not currently assigned to another task in the order pick-up processing server, assign the order to that personnel to prepare, and provide a message to the personnel (e.g., via an electronic device carried by the personnel) with the information needed to collect or prepare the items in the order for pick-up. Certain other means for accomplishing these objectives are known in the art and may be applied to the methods and systems of the present disclosure by a person of skill in the art with the benefit of this disclosure. In any embodiment, the items in the customer's order are prepared and made available for pick-up at a designated area at the pick-up facility as a result of sub-process 140.

At block 115 or 121, the customer reports to a designated area at the pick-up facility for picking up the items in his order. In the instance where the customer provided notice of his arrival at the pick-up facility via block 107, the designated area may simply be the same area where the customer provided that notice, and the customer may still be in that area. This designated area may be a fixed location within or in the vicinity of the pick-up facility pre-designated for pick-up of all orders at the facility, or alternatively may be an area specifically designated for pick-up of a specific customer's order. In the latter case, the designated pick-up area may be selected based on any number of factors, including but not limited to proximity to the putaway locations for one or more items in the order. In certain embodiments, the designated pick-up area may comprise a “curbside” location at the pick-up facility where customer vehicles may be parked or located, such that the purchased items may be placed directly in the customer's vehicle. Once the customer reports to the designated area, an attendant or other personnel at the pick-up facility (which may be the same personnel who collected items in the order, or different personnel responsible for tendering items to the customer) validates identification provided by the customer, for example, in the form of a government-issued ID, a retailer-issued ID, a unique machine-readable code or other identifying information provided by the customer's personal electronic device, or any other suitable form, at block 150. Personnel may then tender the items in the order to the customer at block 160, at which point the personnel and/or the customer may check the items for completeness and quality. Once the complete order has been provided to the customer, the customer may sign for or otherwise acknowledge receipt of the order at block 170, which completes fulfillment of the order. In certain embodiments, the customer's signature or acknowledgement may be captured and recorded by the retailer either electronically or in another suitable form to complete their data record for the order. In certain embodiments, the customer may have provided payment for the items in the order when the order was placed or at some other point in time prior to pick-up. However, in some embodiments, if the customer has not provided payment for one or more of the items in the order, the personnel providing the items to the customer optionally may receive and/or process payment from the customer for those items at some point between or during the steps in blocks 150, 160, and/or 170.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method comprising:
receiving a customer arrival notification for a customer to pick up at a pick-up facility one or more items purchased from a retailer in an order previously placed by the customer;
determining an estimated order pick-up time for the order; and
providing an electronic pick-up notification to the customer that includes the estimated order pick-up time.

2. The method of claim 1 wherein the estimated order pick-up time for the order is determined based at least in part on one or more of the following factors: a number of runner personnel on duty at the pick-up facility; a number of runner personnel available at the pick-up facility; a number of other pick-up orders in a queue awaiting preparation for pick-up at the pick-up facility; a number of items in the customer's order; a number of putaway locations for the items in the customer's order; a customer traffic factor; and any combination thereof.

3. The method of claim 1 further comprising:
collecting or preparing the items in the order; and
providing the items in the order to the customer at the pick-up facility.

4. The method of claim 3 wherein the items are provided to the customer at a curbside location at the pick-up facility.

5. The method of claim 1 wherein the pick-up facility is a retail store operated by the retailer.

6. The method of claim 1 wherein the customer arrival notification is in the form of an email message, a text message, a push notification, an instant message, an audio recording, or a video recording.

7. The method of claim 1 wherein the customer arrival notification is a text message that includes the customer's phone number.

8. The method of claim 1 wherein the items comprise at least one perishable food item.

9. A computer program stored in a tangible medium for processing information relating to the pick-up of online retail orders, the program comprising a plurality of instructions that when executed cause at least one processor to:
receive a customer arrival notification for a customer to pick up at a pick-up facility one or more items purchased from a retailer in an order previously placed by the customer;
determine an estimated order pick-up time for the order; and
provide an electronic pick-up notification to the customer that includes the estimated order pick-up time.

10. The computer program of claim 9 wherein the pick-up facility is a retail store operated by the retailer.

11. The computer program of claim 9 wherein the estimated order pick-up time for the order is determined based at least in part on one or more of the following factors: a number of runner personnel on duty at the pick-up facility; a number of runner personnel available at the pick-up facility; a number of other pick-up orders in a queue awaiting preparation for pick-up at the pick-up facility; a number of items in the customer's order; a number of putaway locations for the items in the customer's order; a customer traffic factor; and any combination thereof.

12. The computer program of claim 9 wherein the customer arrival notification is in the form of an email message, a text message, a push notification, an instant message, an audio recording, or a video recording.

13. The computer program of claim 9 wherein the customer arrival notification is a text message that includes the customer's phone number.

14. A system for managing pick-up of online retail orders comprising:
a data server that comprises
at least one processor,
a communications interface configured to receive data from and send data to one or more client systems, and
a memory comprising executable instructions that, when executed, cause the at least one processor to:
receive a customer arrival notification for a customer to pick up at a pick-up facility one or more items purchased from a retailer in an order previously placed by the customer;
determine an estimated order pick-up time for the order; and
provide an electronic pick-up notification to the customer that includes the estimated order pick-up time.

15. The system of claim 14 wherein the pick-up facility is a retail store operated by the retailer.

16. The system of claim 14 wherein the estimated order pick-up time for the order is determined based at least in part on one or more of the following factors: a number of runner personnel on duty at the pick-up facility; a number of runner personnel available at the pick-up facility; a number of other pick-up orders in a queue awaiting preparation for pick-up at the pick-up facility; a number of items in the customer's order; a number of putaway locations for the items in the customer's order; a customer traffic factor; and any combination thereof.

17. The system of claim 14 wherein the customer arrival notification is in the form of an email message, a text message, a push notification, an instant message, an audio recording, or a video recording.

18. The system of claim 14 wherein the customer arrival notification is a text message that includes the customer's phone number.

19. The system of claim 14 further comprising one or more computing devices in communication with the data server that are configured to provide the customer arrival notification to the data server and provide the electronic pick-up notification to the customer.
